(19) United States
(12) Patent Application Publication
(10) Pub. No.: US 2026/0360257 A1
(43) Pub. Date: Nov. 12, 2026

(54) NAVIGATION ASSISTANCE DEVICE AND NAVIGATION ASSISTANCE METHOD

(71) Applicant: Furuno Electric Co., Ltd., Nishinomiya (JP)

(72) Inventor: Naohiro KANAMARU, Amagasaki (JP)

(21) Appl. No.: 19/674,909

(22) Filed: May 12, 2026

(30) Foreign Application Priority Data
May 12, 2025 (JP) 2025-080004

(51) Int. Cl. G08G 3/02; B63B 43/18; B63B 49/00; G01S 13/72; G01S 13/937; G06F 3/14

(52) U.S. Cl. CPC G08G 3/02; B63B 43/18; B63B 49/00; G01S 13/72; G01S 13/937; G06F 3/14

(57) ABSTRACT

A navigation assistance device is capable of optimizing a timing of switching of a display mode of a risk area. The navigation assistance device includes processing circuitry. The processing circuitry: based on the first ship data, the second ship data, and a threshold, determines a risk level with respect to the risk area; receives setting of the threshold; and displays the risk area in a display mode corresponding to the risk level in an image indicating a positional relationship among the first ship, the second ship, and the risk area, and cause a timing of switching of the display mode to differ between a normal display mode and a setting reception mode in which the setting of the threshold is received.

### CROSS-REFERENCE TO RELATED APPLICATION(S)

The application claims priority under 35 U.S.C. §119 to Japanese Patent Application No. 2025-080004, which was filed on May 12, 2025, the entire disclosure of which is hereby incorporated by reference.

### Technical Field

The disclosure relates to a navigation assistance device, a navigation assistance method, and a program.

Conventional art documents disclose a technology in which, when a ship navigates based on a navigation schedule, a future collision risk between the ship and another ship is calculated, and the calculated collision risk is further weighted by time until reaching a future state, and collision risks considering temporal confidence are sequentially calculated.

### SUMMARY

### Technical Problem

Conventionally, a technology is known in which a risk area where there is a risk of collision between a ship and another ship is visualized. In the case of displaying the risk area in a display mode such as a color corresponding to a risk level, it is important to optimize a timing of switching according to a state of a user interface.

The disclosure has been made in view of the above problems, and a main purpose thereof is to provide a navigation assistance device, a navigation assistance method, and a program capable of optimizing a timing of switching of a display mode of a risk area.

### Solution to Problem

To solve the above problems, a navigation assistance device according to one aspect of the disclosure includes: a first acquiring unit, acquiring first ship data including position and speed of a first ship; a second acquiring unit, acquiring second ship data including position and speed of a second ship; a risk area calculating unit, based on the first ship data and the second ship data, calculating a risk area where there is a risk of collision between the first ship that is assumed to proceed in an arbitrary direction and the second ship that is assumed not to change course; a risk level determining unit, based on the first ship data, the second ship data, and a threshold, determining a risk level with respect to the risk area; a setting receiving unit, receiving setting of the threshold; and a display control unit, displaying the risk area in a display mode corresponding to the risk level in an image indicating a positional relationship between the first ship, the second ship, and the risk area, and causing a timing of switching of the display mode to differ between a normal display mode and a setting reception mode in which the setting of the threshold is received. According to this, it is possible to optimize the timing of switching of the display mode of the risk area.

In the above aspect, the display control unit may cause a switching time from changing of the risk level until switching of the display mode to differ between the normal display mode and the setting reception mode. According to this, it is possible to optimize the switching time from changing of the risk level until switching of the display mode.

In the above aspect, the display control unit may make the switching time in the setting reception mode shorter than the switching time in the normal display mode. According to this, it is possible to stably display the risk area in the normal display mode and to allow a user to quickly grasp the influence of setting of thresholds in the setting reception mode.

In the above aspect, the setting reception mode may be a state in which a setting screen that receives the setting of the threshold is displayed, and the normal display mode may be a state in which the setting screen is not displayed. According to this, it is possible to allow the user to grasp the influence of setting of thresholds when the setting screen is displayed.

In the above aspect, the display control unit may switch the display mode in the case where the same risk level continues for a particular time in the normal display mode. According to this, it is possible to stably display the risk area.

In the above aspect, the display control unit may immediately switch the display mode in response to a change in the risk level in the setting reception mode. According to this, it is possible to allow the user to quickly grasp the influence of setting of thresholds.

In the above aspect, there may be at least two thresholds, and there may be at least three risk levels. According to this, it is possible to display the risk area in display modes corresponding to multiple risk levels.

In the above aspect, the threshold may be a time threshold. The risk level determining unit may, based on the first ship data and the second ship data, calculate a time risk value based on time until the first ship reaches the risk area, compare the time risk value with the time threshold, and determine the risk level. According to this, it is possible to determine the risk level based on the time risk value.

In the above aspect, the setting receiving unit may receive setting of the time threshold. According to this, it is possible to receive setting of the time threshold.

In the above aspect, the threshold may be a distance threshold. The risk level determining unit may, based on the first ship data and the second ship data, calculate a distance risk value based on a distance from the first ship to the risk area on a course of the first ship, compare the distance risk value with the distance threshold, and determine the risk level. According to this, it is possible to determine the risk level based on the distance risk value.

In the above aspect, the setting receiving unit may receive setting of the distance threshold. According to this, it is possible to receive setting of the distance threshold.

In the above aspect, the threshold may be a time threshold and a distance threshold. The risk level determining unit may, based on the first ship data and the second ship data, calculate a time risk value based on time until the first ship reaches the risk area and a distance risk value based on a distance from the first ship to the risk area on a course of the first ship, compare the time risk value with the time threshold, compare the distance risk value with the distance threshold, and determine the risk level. According to this, it is possible to determine the risk level based on the time risk value and the distance risk value.

In the above aspect, the first ship data may include the position of the first ship measured by a positioning device mounted on the first ship. According to this, it is possible to acquire the position of the first ship measured by the positioning device.

In the above aspect, the second ship data may include the position and speed of the second ship detected by a radar or AIS mounted on the first ship. According to this, it is possible to acquire the position and speed of the second ship detected by a radar or AIS.

A navigation assistance method according to another aspect of the disclosure includes the following. First ship data including position and speed of a first ship is acquired. Second ship data including position and speed of a second ship is acquired. A risk area where there is a risk of collision between the first ship that is assumed to proceed in an arbitrary direction and the second ship that is assumed not to change course is calculated based on the first ship data and the second ship data. A risk level with respect to the risk area is determined based on the first ship data, the second ship data, and a threshold. The risk area is displayed in a display mode corresponding to the risk level in an image indicating a positional relationship between the first ship, the second ship, and the risk area. A timing of switching of the display mode is caused to differ between a normal display mode and a setting reception mode in which setting of the threshold is received. According to this, it is possible to optimize the timing of switching of the display mode of the risk area.

A program according to another aspect of the disclosure causes a computer to execute: acquiring first ship data including position and speed of a first ship; acquiring second ship data including position and speed of a second ship; based on the first ship data and the second ship data, calculating a risk area where there is a risk of collision between the first ship that is assumed to proceed in an arbitrary direction and the second ship that is assumed not to change course; based on the first ship data, the second ship data, and a threshold, determining a risk level with respect to the risk area; receiving setting of the threshold; displaying the risk area in a display mode corresponding to the risk level in an image indicating a positional relationship between the first ship, the second ship, and the risk area; and causing a timing of switching of the display mode to differ between a normal display mode and a setting reception mode in which the setting of the threshold is received. According to this, it is possible to optimize the timing of switching of the display mode of the risk area.

### Effects of Invention

According to the disclosure, it is possible to optimize a timing of switching of a display mode of a risk area.

### BRIEF DESCRIPTION OF THE DRAWINGS

FIG. 1 is a diagram showing an example of an integrated navigation system.

FIG. 2 is a diagram showing an example of a display image.

FIG. 3 is a diagram showing an example of a virtual three-dimensional space VS.

FIG. 4 is a diagram showing an example of a display image.

FIG. 5 is a diagram showing an example of a display image.

FIG. 6 is a diagram showing an example of a navigation assistance device.

FIG. 7 is a diagram showing an example of a risk level determining unit.

FIG. 8 is a diagram showing an example of an other ships management database.

FIG. 9 is a diagram describing calculation of a risk area.

FIG. 10 is a diagram describing display of a risk area.

FIG. 11 is a diagram describing calculation of a risk value.

FIG. 12 is a diagram describing determination of a risk level.

FIG. 13 is a diagram showing an example of a navigation assistance method.

### DESCRIPTION OF THE EMBODIMENTS

Hereinafter, embodiments of the disclosure will be described with reference to the drawings. In this specification and each drawing, the same reference numerals are assigned to elements similar to those described above with respect to previously shown drawings, and detailed descriptions may be appropriately omitted.

### System Overview

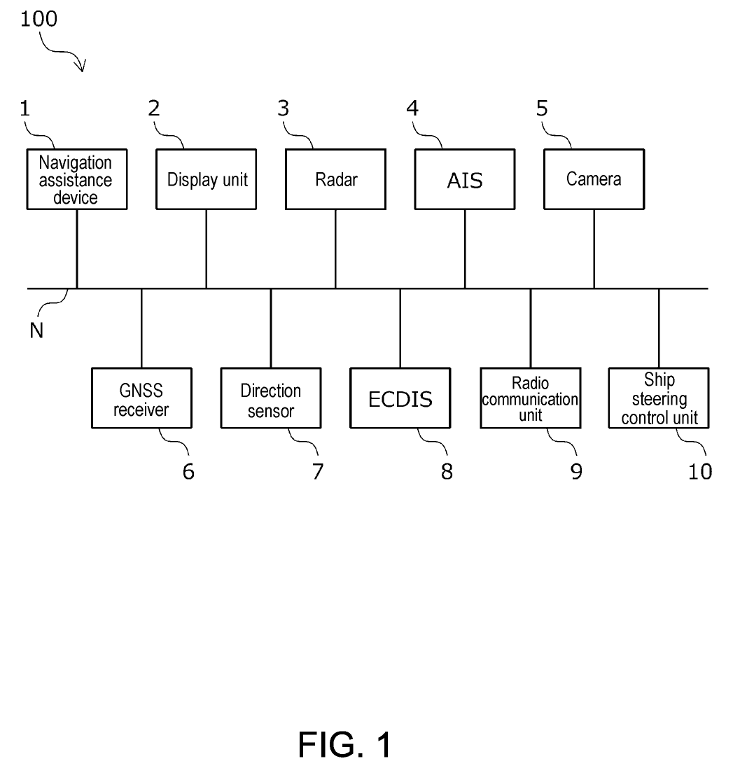

FIG. 1 is a block diagram showing a configuration example of an integrated navigation system 100. The integrated navigation system 100 is a system mounted on a ship. In the following description, the ship on which the integrated navigation system 100 is mounted is also referred to as “the ship,” and any other ship or ships are also referred to as “another ship” or “other ships.”

The integrated navigation system 100 includes a navigation assistance device 1, a display unit 2, a radar 3, an automatic identification system (AIS) 4, a camera 5, a global navigation satellite system (GNSS) receiver 6, a direction sensor 7, an electronic chart display and information system (ECDIS) 8, a radio communication unit 9, and a ship steering control unit 10. These devices are connected to a network N such as a LAN, and are capable of mutual network communication.

The navigation assistance device 1 includes a computer that includes a central processing unit (CPU), a random access memory (RAM), a read-only memory (ROM), a nonvolatile memory, an input and output interface, and the like. The CPU executes information processing in accordance with a program loaded from the ROM or nonvolatile memory to the RAM. The program may be provided to the navigation assistance device 1 via a non-transitory storage medium, or may be provided to the navigation assistance device 1 via a communication line.

The display unit 2 displays a display image generated by the navigation assistance device 1. The display unit 2 also displays a radar image, an electronic chart, or a camera image or the like. The display unit 2 is, for example, a display device with a touch sensor, a so-called touch panel, and detects an indicated position on a screen indicated by a user’s finger or the like. The disclosure is not limited thereto. The indicate positions may be input by a pointing device such as a trackball.

The radar 3 emits radio waves around the ship, receives reflected waves thereof, and generates echo data based on a received signal. The radar 3 identifies a target object such as another ship from the echo data, and generates target tracking (TT) data representing a position and velocity of the target object.

The AIS 4 receives AIS data from another ship present around the ship or from a land control. The disclosure is not limited to an AIS, and a very high frequency (VHF) data exchange system (VDES) may also be used. The AIS data includes an identification code, ship name, position, course, ship speed, ship type, hull length, and destination or the like of the another ship.

The camera 5 is a digital camera that captures an image of the outside from the ship and generates image data. The camera 5 is installed, for example, on a bridge of the ship facing a bow heading. The camera 5 is, for example, a so-called pan-tilt-zoom (PTZ) camera having pan and tilt functions and an optical zoom function.

The camera 5 may include an image recognition part that estimates, by an object detection model, an in-image position and type of a target object such as another ship included in a captured image. The image recognition part is not limited to the camera 5, and may be realized in other devices such as the navigation assistance device 1.

The GNSS receiver 6 is a positioning device that detects a position of the ship based on radio waves received from the GNSS. The direction sensor 7 detects the bow heading of the ship. The direction sensor 7 is, for example, a global positioning system (GPS) compass or a gyrocompass.

The ECDIS 8 acquires the position of the ship from the GNSS receiver 6, and displays the position of the ship on an electronic chart. The ECDIS 8 displays a planned route of the ship on the electronic chart. The disclosure is not limited to an ECDIS, and a GNSS plotter may also be used.

The radio communication unit 9 includes radio equipment that realizes satellite communication. The radio communication unit 9 includes radio equipment that realizes ship-to-shore or ship-to-ship radio communication using, for example, microwave, ultrashort wave, shortwave or intermediate wave.

The ship steering control unit 10 is a control device that controls a steering gear of the ship to realize autonomous navigation. The ship steering control unit 10 may further control an engine of the ship.

In the present embodiment, the navigation assistance device 1 and the display unit 2 are devices independent of each other. However, the disclosure is not limited thereto. The navigation assistance device 1 and the display unit 2 may be an integrated device.

The navigation assistance device 1 is not limited to an independent device, and may be integrated with other devices such as the ECDIS 8. That is, some or all of the functions of the navigation assistance device 1 may be realized by other devices.

The display unit 2 is not limited to an independent device, and a display unit of other devices such as the ECDIS 8 may be used as the display unit 2 that displays the display image generated by the navigation assistance device 1.

In addition, the navigation assistance device 1 and the display unit 2 may be, for example, installed in a land control and used to monitor ships navigating in a managed sea area.

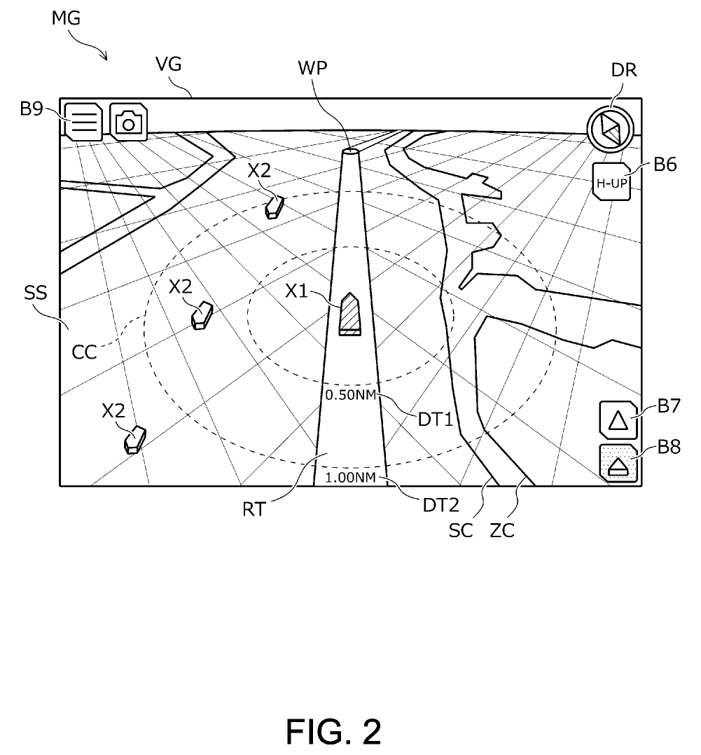

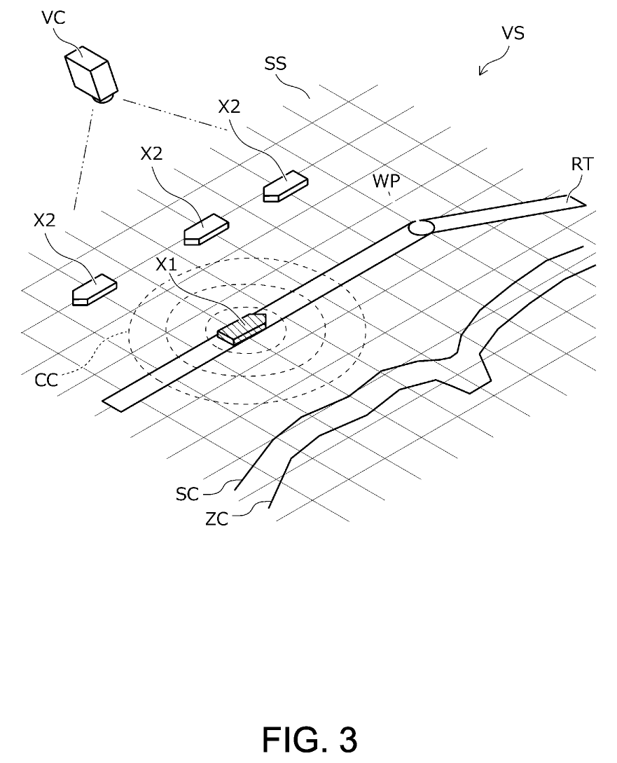

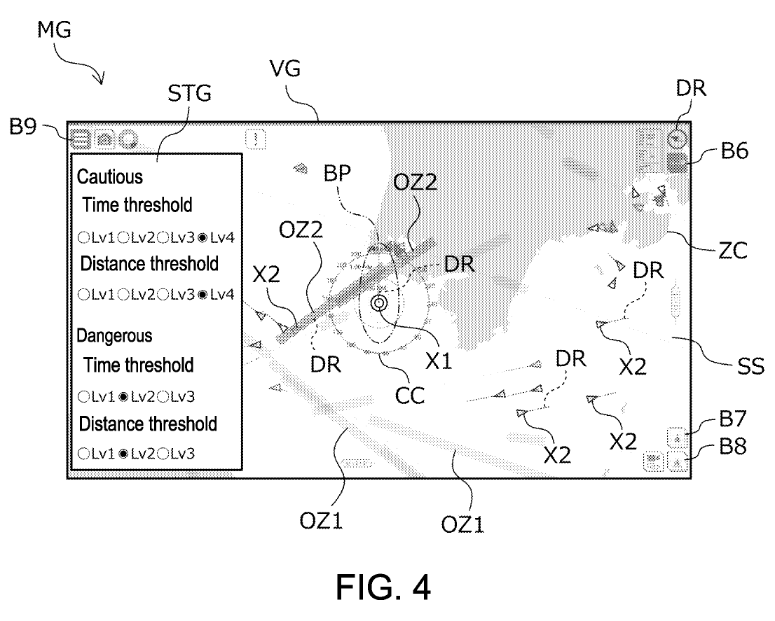

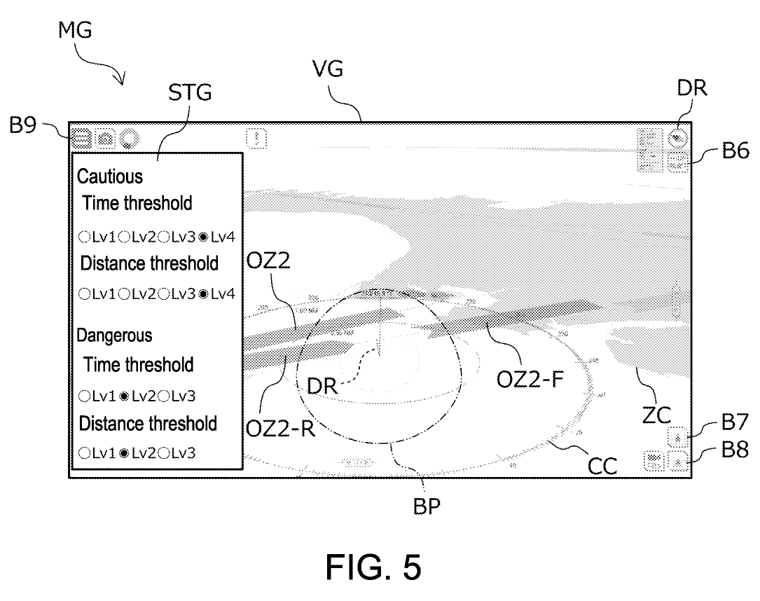

FIG. 2 is a diagram showing an example of a display image MG generated by the navigation assistance device 1 and displayed on the display unit 2. FIG. 3 is a diagram showing an example of a virtual three-dimensional space VS for generating a virtual scene image VG included in the display image MG. FIGS. 4 and 5 are diagrams showing specific examples of the display image MG.

The navigation assistance device 1 sequentially generates the display images MG at each time point based on data acquired from other devices such as the radar 3, AIS 4, camera 5, and GNSS receiver 6, and outputs moving image data including the display images MG in a time series to the display unit 2.

The display image MG mainly includes the virtual scene image VG. The virtual scene image VG is an image that depicts a scene within a field of view of a virtual camera VC set in the virtual three-dimensional space VS. FIGS. 2 and 3 show an example of a bird’s-eye view mode in which a virtual water surface SS is looked down obliquely from a particular height.

The virtual three-dimensional space VS has a coordinate system corresponding to a real space. A height of the virtual water surface SS corresponds to a height (for example, 0 m above sea level) of a water surface in the real space.

Ship objects X are arranged on the virtual water surface SS. The ship objects X are, for example, three-dimensional objects. The ship objects X include a ship object X1 (also referred to as “the ship object X1”) representing the ship and a ship object X2 (also referred to as “other ships object X2”) representing another ship.

The ship object X1 is arranged at a position on the virtual water surface SS corresponding to a two-dimensional position of the ship in the real space. The other ships object X2 is also arranged at a position on the virtual water surface SS corresponding to a two-dimensional position of the another ship in the real space.

Concentric circles CC centered on the ship object X1 may be arranged in the virtual three-dimensional space VS. Character strings DT1 and DT2 representing distances may be added to the concentric circles CC. Scales and numerical values indicating directions may be added to the outermost ring of the concentric circles CC.

A route object RT indicating the planned route of the ship and a course change point object WP indicating a waypoint of the planned route, or the like, may be arranged in the virtual three-dimensional space VS.

A coastline ZC and a safety contour SC may be arranged in the virtual three-dimensional space VS. The coastline ZC and the safety contour SC are created based on chart data. The chart data is, for example, data of an electronic navigational chart (ENC).

In addition, in the virtual three-dimensional space VS, a mark indicating an intersection of a display line of sight and the virtual water surface SS, an object indicating echo intensity detected by the radar 4, or a range circle indicating a detection range of the radar 4 or the like may further be arranged.

The display image MG includes a compass object DR and buttons B6 to B9 in addition to the virtual scene image VG. The compass object DR is an object indicating directions such as north and south, like a compass.

Button B6 is a button for switching a direction corresponding to the upper part of the virtual scene image VG between the bow heading (H-UP) of the ship and the north direction (N-UP). FIG. 2 shows an example in which the upper part of the virtual scene image VG corresponds to the bow heading of the ship.

Button B7 is a button for switching a display viewpoint to a top view mode, and button B8 is a button for switching the display viewpoint to the bird’s-eye view mode. FIG. 4 is a diagram showing an example of the top view mode, and FIG. 5 is a diagram showing an example of the bird’s-eye view mode.

Button B9 is a button for displaying a setting screen STG in the display image MG. The setting screen STG will be described later in details.

The ship object X1 and the other ships object X2 are not limited to three-dimensional objects, and may be two-dimensional symbols having no height, as shown in FIG. 4. In FIG. 4, the ship object X1 is displayed as a double circle, the other ships object X2 is displayed as a triangle, and a direction line DR representing a path or a course is further added. As shown in FIG. 5, the ship object X1 may be omitted and only the direction line DR of the ship may be displayed.

As shown in FIGS. 4 and 5 , risk areas OZ1 and OZ2 (hereinafter also collectively referred to as “risk area OZ”) where there is a risk of collision between the ship and other ships are further displayed in the display image MG. The risk area OZ is, for example but not limited to, an obstacle zone by target (OZT), and may also be a collision point, a predict area of dangerous (PAD) or dangerous area of collision (DAC), or the like.

In the present embodiment, the risk area OZ is displayed in a display mode corresponding to a risk level. The display mode is, for example, a color. The risk area OZ with a higher risk level may be displayed with higher saturation or brightness. The disclosure is not limited thereto. The shape or pattern or the like of the risk area OZ may be changed.

There are three risk levels, “safe,” “cautious,” and “dangerous,” and the display mode changes in three stages correspondingly to these risk levels. In the example of FIG. 4, displayed are the risk area OZ1 displayed in the “safe” display mode and the risk area OZ2 displayed in the “cautious” display mode.

As shown in FIGS. 4 and 5 , the setting screen STG may be displayed in the display image MG. The setting screen STG is a screen that receives setting of thresholds for determining the risk level of the risk area OZ.

The thresholds include a threshold for determining “cautious” and a threshold for determining “dangerous.” By applying these thresholds, the risk level is determined in three stages: “safe,” “cautious,” and “dangerous.”

Specifically, determination criteria for the risk level include a time risk value and a distance risk value, and a time threshold and a distance threshold are respectively applied thereto.

The time threshold and distance threshold for determining “cautious” can each be set in multiple stages Lv1 to Lv4; the time threshold and distance threshold for determining “dangerous” can each be set in multiple stages Lv1 to Lv3. The number of stages that can be set is not limited to the number shown in the drawings. The determination of the risk level will be described later in details.

The setting screen STG is switched between being displayed and not being displayed by pressing of button B9. As shown in FIG. 2, a state in which the setting screen STG is not displayed is a “normal display mode;” as shown in FIGS. 4 and 5 , a state in which the setting screen STG is displayed is a “setting reception mode.”

In the normal display mode, stable display is required so that the display mode of the risk area OZ does not switch frequently. In contrast, in the setting reception mode, it is required to allow the user to quickly grasp the influence of setting of thresholds.

Accordingly, in the present embodiment, as will be described later, a timing of switching of the display mode of the risk area OZ is caused to differ between the normal display mode and the setting reception mode.

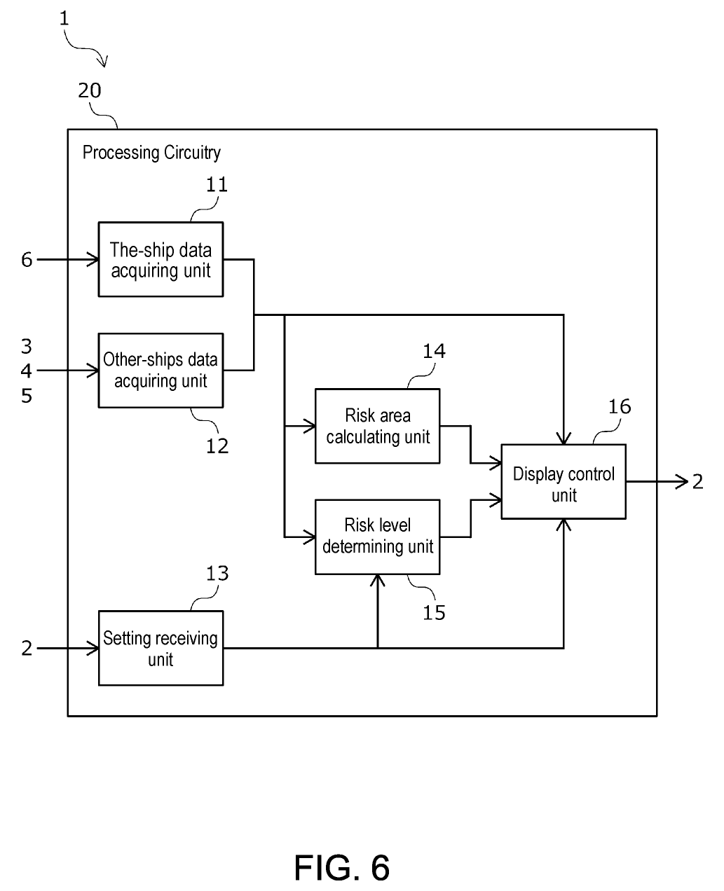

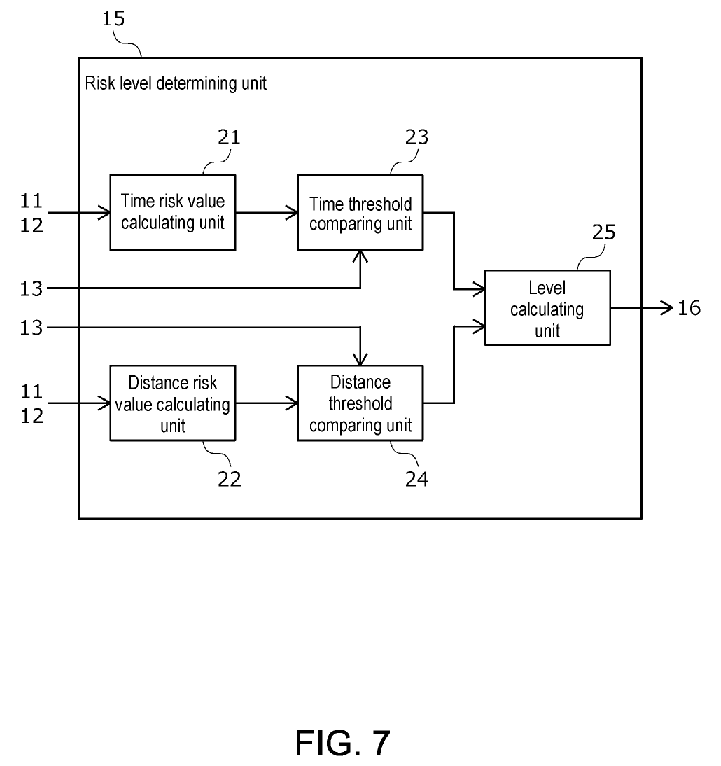

FIGS. 6 and 7 are block diagrams showing functional configuration examples of the navigation assistance device 1. The navigation assistance device 1 includes processing circuitry 20. The processing circuitry 20 is a computer including a CPU, a RAM, a ROM, a nonvolatile memory, an input and output interface, and the like.

As shown in FIG. 6, the processing circuitry 20 includes a the-ship data acquiring unit 11, an other-ships data acquiring unit 12, a setting receiving unit 13, a risk area calculating unit 14, a risk level determining unit 15, and a display control unit 16. These functional units are realized by the processing circuitry 20 executing information processing in accordance with a program.

As shown in FIG. 7, the risk level determining unit 15 includes a time risk value calculating unit 21, a distance risk value calculating unit 22, a time threshold comparing unit 23, a distance threshold comparing unit 24, and a level calculating unit 25.

The the-ship data acquiring unit 11 acquires the-ship data including the position and velocity of the ship. Velocity is a vector quantity expressed by speed and direction, and speed is a scalar quantity. The direction is a path, but may be a course (bow heading). The position is expressed by geographical coordinates representing a two-dimensional position in the real space. The the-ship data may be data including the position and speed of the ship.

Specifically, the the-ship data acquiring unit 11 sequentially acquires the position of the ship detected by the GNSS receiver 6, and calculates the velocity of the ship from a temporal change in the position of the ship. The disclosure is not limited thereto. The speed of the ship may be acquired from a ship speed meter (not shown), and the direction of the ship may be acquired from the direction sensor 7.

With respect to each of multiple other ships present around the ship, the other-ships data acquiring unit 12 acquires other-ships data including the position and velocity of the other ships. The other-ships data is generated based on data detected by the radar 3, AIS 4, or camera 5 mounted on the ship. The other-ships data may be acquired from the outside by radio communication.

Specifically, the other-ships data acquiring unit 12 sequentially acquires, as the other-ships data, the TT data generated by the radar 3, the AIS data received by the AIS 4, or identification data identified from an image captured by the camera 5. The other-ships data acquiring unit 12 registers the acquired other-ships data in an other ships management database constructed in a memory.

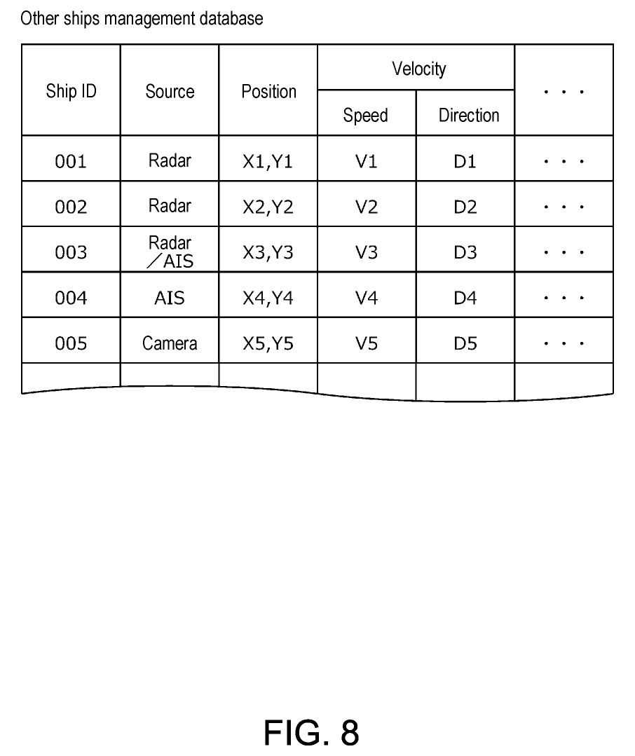

As shown in FIG. 8, the other ships management database includes fields such as “ship ID,” “source,” “position,” “speed,” and “direction.” The “ship ID” is an identifier assigned to the other ships. The “source” indicates whether the other-ships data was generated by the radar 3, AIS 4, or camera 5.

The “position” represents the position of the other ships. The position of the other ships is expressed by latitude and longitude. Since the position of the other ships detected by the radar 3 or camera 5 is a relative position with respect to the ship, the position of the other ships may be converted to an absolute position using the position of the ship detected by the GNSS receiver 6.

The “speed” represents the speed of the other ships. The “direction” represents the direction of the other ships. The speed and direction of the other ships detected by the radar 3 or camera 5 are estimated from a temporal change in the position of the other ships in the image.

In the case where the position in the other-ships data of which the source is one of the AIS 3, radar 4, and camera 5 is the same as or similar to the position in the other-ships data of which the source is another one of the AIS 3, radar 4, and camera 5, the records may be integrated into one record because those other-ships data are related to another ship which is common.

In the present embodiment, the other ships detected by the AIS 3, radar 4, or camera 5 are managed as a display target. However, the disclosure is not limited thereto. A target object other than the other ships, such as a buoy, an iceberg, or a floating container detected by the radar 4 or camera 5, may also be used as the target.

Returning to the description of FIG. 6, the setting receiving unit 13 receives an operation input from the user detected by the touch sensor of the display unit 2, and outputs input data representing the operation input to the risk level determining unit 15 and the display control unit 16.

Specifically, the setting receiving unit 13 detects pressing of button B9 in the display image MG (see FIGS. 2 and 4-5 ) displayed on the display unit 2, and notifies the display control unit 16. In response to the pressing of button B9, the display control unit 16 switches between the normal display mode and the setting reception mode in which the setting screen STG is displayed.

When the setting receiving unit 13 receives the setting of thresholds on the setting screen STG (see FIGS. 4 and 5 ) in the setting reception mode, the setting receiving unit 13 notifies the risk level determining unit 15 of a set threshold. The risk level determining unit 15 determines a risk level of the risk area OZ using the set threshold.

Based on the-ship data acquired by the-ship data acquiring unit 11 and the other-ships data acquired by the other-ships data acquiring unit 12, the risk area calculating unit 14 calculates the risk area OZ where there is a risk of collision between the ship that is assumed to proceed in an arbitrary direction and another ship that is assumed not to change course.

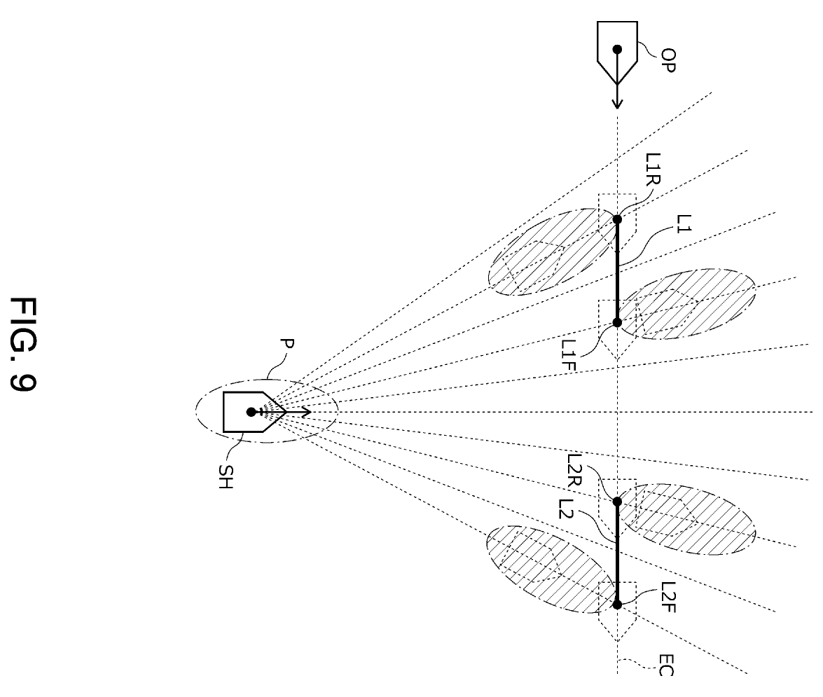

A calculation example of the risk area OZ is described with reference to FIG. 9. When it is assumed that the ship SH changes course, navigates in an arbitrary direction and reaches a predicted route EC of another ship OP, based on predicted positions of the ship SH and the another ship OP at each time point, the risk area calculating unit 14 specifies, as a section for displaying the risk area OZ, risk sections L1 and L2 of the predicted route EC of the another ship OP where there is a risk of collision between the ship SH and the another ship OP.

The calculation of the predicted position of the ship SH is performed under an assumption that the ship SH changes course in an arbitrary direction at the current position and navigates while maintaining speed. That is, it is assumed that, while the ship SH has a constant magnitude of the ship velocity vector, the direction of the ship velocity vector changes to an arbitrary direction at a reference time point, and thereafter, the ship SH continues navigation in a constant direction from the ship position at the reference time point. Accordingly, the predicted position of the ship SH at each time point exists on concentric circles centered on the ship position at the reference time point. The radius of the circle is expressed by the product of the elapsed time from the reference time point and the magnitude of the ship velocity vector.

The predicted position of the ship SH at each time point is represented by multiple concentric circles calculated with respect to each of multiple discrete time points. The disclosure is not limited thereto. The predicted position of the ship SH at each time point may be represented by an expression of a circle including the elapsed time from the reference time point.

In the present embodiment, the predicted position of the ship SH is calculated under an assumption that the ship SH has a constant speed. However, the disclosure is not limited thereto. The speed of the ship SH may be treated as a variable that changes according to time. That is, if the predicted position of the ship SH according to the elapsed time from the reference time point can be calculated, the speed of the ship SH does not need to be constant. For example, the speed of the ship SH may gradually increase or decrease as the time elapses.

The calculation of the predicted position of the another ship OP is performed under an assumption that the another ship OP navigates while maintaining velocity from the current position. That is, it is assumed that, the another ship OP has constant magnitude and direction of the other ship velocity vector and continues navigation from the other ship position at the reference time point. Accordingly, the predicted position of the another ship OP at each time point exists on a straight line passing through the other ship position at the reference time point and on an extension of the other ship velocity vector.

The predicted position of the another ship OP at each time point is represented by multiple discrete points arranged on a straight line that are calculated with respect to each of multiple discrete time points. The disclosure is not limited thereto. The predicted position of the another ship OP at each time point may be represented by a linear function passing through the other ship position at the reference time point.

In the present embodiment, the predicted position of the another ship OP is calculated under an assumption that the another ship OP has a constant velocity. However, the disclosure is not limited thereto. At least one of the speed and direction of the another ship OP may be treated as a variable that changes according to time. That is, if the predicted position of the another ship OP according to the elapsed time from the reference time point can be calculated, the velocity of the another ship OP does not need to be constant. For example, the speed of the another ship OP may gradually increase or decrease as the time elapses. The another ship OP may change course in a particular direction, or may turn at a particular rate of turn (ROT).

The risk area calculating unit 14 calculates a separation distance between the predicted position of the ship SH and the predicted position of the another ship OP at each time point, and calculates a risk of collision or approach based on the separation distance and ship size. As described above, since the predicted position of the ship SH at a certain time point is represented by a circle, the risk area calculating unit 14 extracts, from the circle representing the predicted position of the ship SH at a certain time point, a position closest to the predicted position of the another ship OP at the same time point, and calculates the separation distance.

The risk area calculating unit 14 specifies the risk sections L1 and L2 by determining that there is a risk of collision in a case where, for example, an alert area P set around the ship SH and a point representing the predicted position of the another ship OP overlap. The disclosure is not limited thereto. There may be a risk of collision in a case where an area of the ship SH and the point representing the predicted position of the another ship OP overlap. Hereinafter, a direction of travel of the another ship OP is also referred to as forward, and the opposite direction is also referred to as rearward.

For example, among the two risk sections L1 and L2, regarding the first risk section L1 located on the rear side, a rear end L1R of the first risk section L1 becomes a position where a front end of the alert area P of the ship SH contacts the point representing the predicted position of the another ship OP. A front end L1F of the first risk section L1 becomes a position where a rear end of the alert area P of the ship SH contacts the point representing the predicted position of the another ship OP.

On the other hand, among the two risk sections L1 and L2, regarding the second risk section L2 located on the front side, a rear end L2R of the second risk section L2 becomes a position where the rear end of the alert area P of the ship SH contacts the point representing the predicted position of the another ship OP. A front end L2F of the second risk section L2 becomes a position where the front end of the alert area P of the ship SH contacts the point representing the predicted position of the another ship OP.

A range between the first risk section L1 and the second risk section L2 becomes a range where the ship SH crosses in front of the another ship OP. On the other hand, a range behind the first risk section L1 and a range in front of the second risk section L2 become ranges where the ship SH crosses behind the another ship OP.

The disclosure is not limited thereto. The risk area calculating unit 14 may determine that there is a risk of collision in a case where the area of the ship SH or the alert area P set around the ship SH overlaps an area of the another ship OP or an alert area set around the another ship OP. The risk area calculating unit 14 may take a collision point where the point representing the predicted position of the ship SH and the point representing the predicted position of the another ship OP overlap as a risk area.

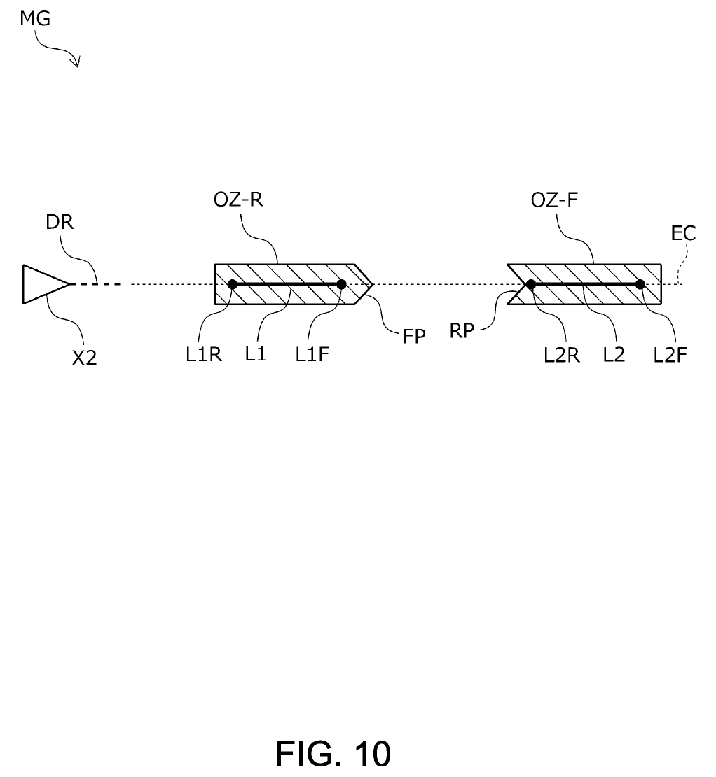

As shown in FIG. 10, in the display image DM, risk areas OZ-F and OZ-R are displayed in the risk sections L1 and L2 calculated by the risk area calculating unit 14. The risk areas OZ-F and OZ-R have a constant width and extend in the same direction as the predicted route EC of the another ship.

Specifically, the risk area OZ-R located on the rear side is displayed in the first risk section L1, and the risk area OZ-F located on the front side is displayed in the second risk section L2.

The shapes of a front end part FP of the risk area OZ-R and a rear end part RP of the risk area OZ-F are different from the shapes of a rear end part of the risk area OZ-R and a front end part of the risk area OZ-F to indicate a range where the ship SH crosses in front of the another ship OP.

In the example of FIG. 10, the front end part FP of the risk area OZ-R and the rear end part RP of the risk area OZ-F have a shape that indicates a direction of travel of the another ship. That is, the front end part FP of the risk area OZ-R has an angular shape that protrudes toward the direction of travel of the another ship, and the rear end part RP of the risk area OZ-F has an angular shape that is recessed toward the direction of travel of the another ship.

Returning to the description of FIGS. 6 and 7 , the risk level determining unit 15 sequentially determines the risk level of the risk area OZ calculated by the risk area calculating unit 14 based on the the-ship data acquired by the the-ship data acquiring unit 11 and the other-ships data acquired by the other-ships data acquiring unit 12.

Specifically, the risk level determining unit 15 calculates a risk value for the ship entering or approaching the risk area OZ, and compares the calculated risk value with a threshold set by the setting receiving unit 13, thereby determining the risk level.

As shown in FIG. 7, based on the the-ship data and the other-ships data, the time risk value calculating unit 21 calculates a time risk value based on the time until the ship reaches the risk area OZ. The time threshold comparing unit 23 compares the time risk value calculated by the time risk value calculating unit 21 with the time threshold set by the setting receiving unit 13.

Based on the the-ship data and the other-ships data, the distance risk value calculating unit 22 calculates a distance risk value based on a distance from the ship to the risk area OZ on the course of the ship. The distance threshold comparing unit 24 compares the distance risk value calculated by the distance risk value calculating unit 22 with the distance threshold set by the setting receiving unit 13.

Based on a result of the comparison made between the time risk value and the time threshold by the time threshold comparing unit 23 and a result of the comparison made between the distance risk value and the distance threshold by the distance threshold comparing unit 24, the level calculating unit 25 determines the risk level.

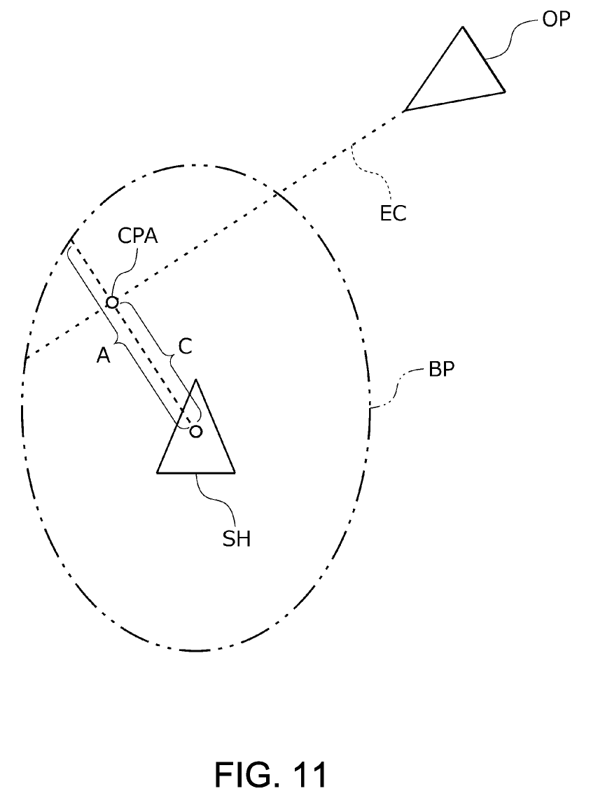

With reference to FIG. 11, a calculation example of the time risk value and the distance risk value is described. The time risk value is a risk value that changes according to, for example, time to closest point of approach (TCPA) in a closest point of approach (CPA) collision alarm. TCPA is time until the another ship OP approaches the closest point CPA of the ship SH. The TCPA is calculated based on a relative velocity vector of the velocity vector of the ship SH and the velocity vector of the another ship OP.

Specifically, the time risk value is a value according to a ratio of the TCPA to a TCPA reference value. For example, the time risk value is defined as 1-TCPA/TCPA reference value, and changes in a range of 0.0 to 1.0. As the TCPA decreases, that is, as the risk of collision increases, the time risk value approaches 1.0. Time to bow crossing (BCT) may be used instead of TCPA.

The distance risk value is expressed by, for example, a degree of intrusion of the another ship OP into a bumper area BP set based on the ship SH. The bumper area BP is, for example but not particularly limited to, an elliptical area extending in a bow heading direction of the ship SH. The degree of intrusion is calculated based on the velocity vector of the ship SH, the velocity vector of the another ship OP, and the bumper area BP.

Specifically, the distance risk value is a value according to a ratio of a distance C from the ship SH to the closest point CPA to a distance A from the ship SH through the closest point CPA to an end of the bumper area BP. For example, the distance risk value is defined as 1-C/A, and changes in a range of 0.0 to 1.0. As the distance C decreases, that is, as the risk of collision increases, the distance risk value approaches 1.0.

The time risk value and the distance risk value are calculated with respect to the predicted position of the another ship OP traveling on the predicted route EC assuming no change of course occurs, similarly to the calculation of the risk area OZ described above. Thus, the time risk value and distance risk value calculated with respect to the another ship OP are also the time risk value and distance risk value calculated with respect to the risk area OZ.

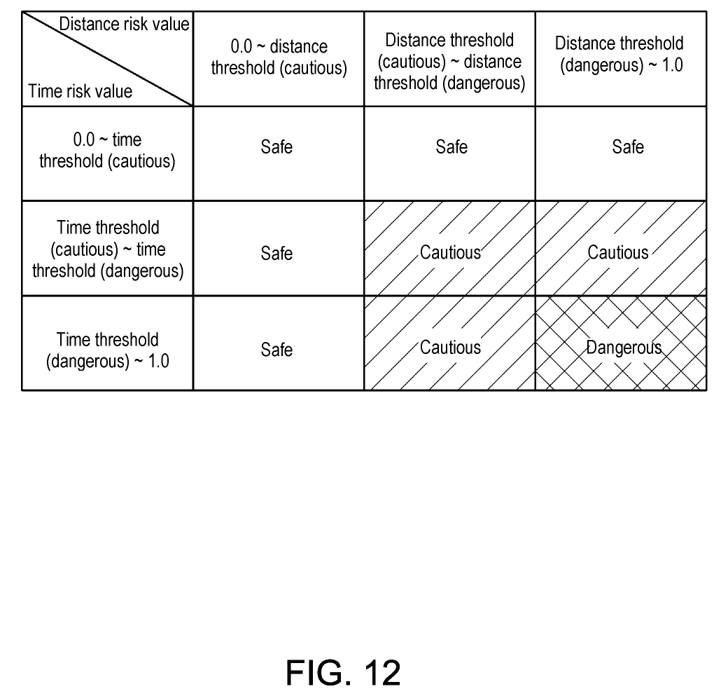

With reference to FIG. 12, a determination example of a risk level is described. For the time risk value, a time threshold (hereinafter also referred to as “time threshold (cautious)”) for determining “cautious” and a time threshold (hereinafter also referred to as “time threshold (dangerous)”) for determining “dangerous” are applied.

For the distance risk value, a distance threshold (hereinafter also referred to as “distance threshold (cautious)”) for determining “cautious” and a distance threshold (hereinafter also referred to as “distance threshold (dangerous)”) for determining “dangerous” are applied.

For example, when the time risk value is equal to or less than the time threshold (cautious), or when the distance risk value is equal to or less than the distance threshold (cautious), the risk level determining unit 15 determines the risk level of the risk area OZ as “safe.”

When the time risk value is equal to or greater than the time threshold (cautious) and equal to or less than the time threshold (dangerous), and the distance risk value is equal to or greater than the distance threshold (cautious), the risk level determining unit 15 determines the risk level of the risk area OZ as “cautious.”

When the distance risk value is equal to or greater than the distance threshold (cautious) and equal to or less than the distance threshold (dangerous), and the time risk value is equal to or greater than the time threshold (cautious), the risk level determining unit 15 determines the risk level of the risk area OZ as “cautious.”

When the time risk value is equal to or greater than the time threshold (dangerous) and the distance risk value is equal to or greater than the distance threshold (dangerous), the risk level determining unit 15 determines the risk level of the risk area OZ as “dangerous.”

Returning to the description of FIG. 6, based on the-ship data acquired by the-ship data acquiring unit 11, the other-ships data acquired by the other-ships data acquiring unit 12, and the risk area calculated by the risk area calculating unit 14, the display control unit 16 generates the display image MG (see FIGS. 2 and 4-5 ) showing a positional relationship between the ship, another ship, and a risk area, and outputs the display image MG to the display unit 2.

Specifically, the display control unit 16 arranges the virtual camera VC, the ship object X1, the other ships object X2, the risk area OZ, and the like in the virtual three-dimensional space VS (see FIG. 3), and depicts a scene within the field of view of the virtual camera VC, thereby generating the virtual scene image VG included in the display image MG.

The display control unit 16 displays the risk area OZ included in the display image MG in a display mode such as a color corresponding to the risk level determined by the risk level determining unit 15.

In the present embodiment, as described below, the display control unit 16 causes a timing of switching of the display mode of the risk area OZ, that is, a switching time from changing of the risk level until switching of the display mode, to differ between the normal display mode and the setting reception mode.

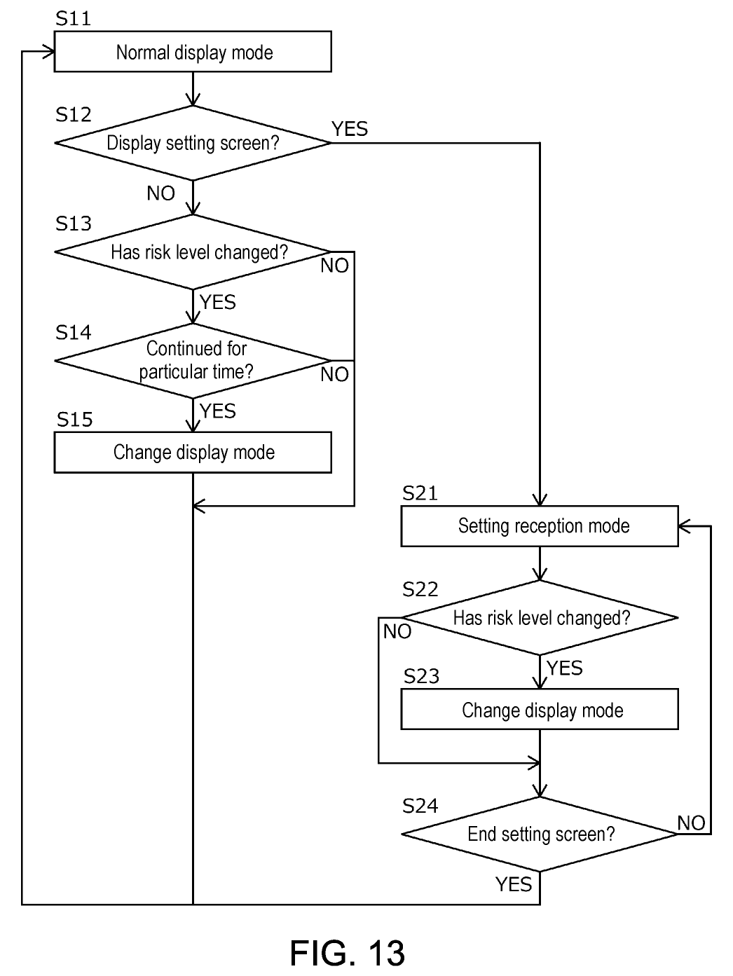

FIG. 13 is a flow diagram showing a procedure example of display control processing related to switching of the display mode of the risk area OZ in a navigation assistance method realized in the integrated navigation system 100. The processing circuitry 20 of the navigation assistance device 1 functions as the display control unit 16 by executing information processing shown in FIG. 13 in accordance with a program.

The display control unit 16 executes the normal display mode and displays the display image MG (S11; see FIG. 2). The normal display mode is continued unless an operation for displaying the setting screen STG is detected (S12: NO).

In the normal display mode, if the risk level of the risk area OZ changes (S13: YES), the display control unit 16 determines whether the same risk level has continued for a particular time (S14).

If the same risk level has continued for a particular time (S14: YES), the display control unit 16 changes the display mode of the risk area OZ (S15). That is, the display control unit 16 switches the display mode when a particular time has elapsed after the risk level of the risk area OZ changes. In other words, a switching time from changing of the risk level until switching of the display mode is set as the particular time.

On the other hand, if the same risk level has not continued for the particular time (S14: NO), the display control unit 16 does not change the display mode of the risk area OZ.

If there is an operation for displaying the setting screen STG (S12: YES), the display control unit 16 executes the setting reception mode and displays the setting screen STG in the display image MG (S21).

In the setting reception mode, if the risk level of the risk area OZ changes (S22: YES), the display control unit 16 immediately changes the display mode of the risk area OZ (S23). That is, the display mode of the risk area OZ is changed without determining the continuation of the particular time as in the normal display mode. In other words, the switching time from changing of the risk level until switching of the display mode is set to approximately 0.

If there is an operation for ending the display of the setting screen STG (S24: YES), the display control unit 16 ends the setting reception mode and returns to the normal display mode.

According to the embodiments described above, by making the switching time in the setting reception mode shorter than the switching time in the normal display mode, it is possible to allow the user to quickly grasp the influence of setting of thresholds in the setting reception mode.

On the other hand, by making the switching time in the normal display mode longer than the switching time in the setting reception mode, it is possible to stably display the risk area OZ so that the display mode of the risk area OZ does not change frequently in the normal display mode.

The embodiments of the disclosure have been described above. However, the disclosure is not limited to the embodiments described above, and it goes without saying that various modifications are possible for those skilled in the art.

Representative embodiments of the disclosure are listed below.

### 1

A navigation assistance device includes: a first acquiring unit, acquiring first ship data including position and speed of a first ship; a second acquiring unit, acquiring second ship data including position and speed of a second ship; a risk area calculating unit, based on the first ship data and the second ship data, calculating a risk area where there is a risk of collision between the first ship that is assumed to proceed in an arbitrary direction and the second ship that is assumed not to change course; a risk level determining unit, based on the first ship data, the second ship data, and a threshold, determining a risk level with respect to the risk area; a setting receiving unit, receiving setting of the threshold; and a display control unit, displaying the risk area in a display mode corresponding to the risk level in an image indicating a positional relationship between the first ship, the second ship, and the risk area, and causing a timing of switching of the display mode to differ between a normal display mode and a setting reception mode in which the setting of the threshold is received.

### 2

In the navigation assistance device described in (1), the display control unit causes a switching time from changing of the risk level until switching of the display mode to differ between the normal display mode and the setting reception mode.

### 3

In the navigation assistance device described in (2), the display control unit makes the switching time in the setting reception mode shorter than the switching time in the normal display mode.

### 4

In the navigation assistance device described in any one of (1) to (3), the setting reception mode is a state in which a setting screen that receives the setting of the threshold is displayed, and the normal display mode is a state in which the setting screen is not displayed.

### 5

In the navigation assistance device described in any one of (1) to (4), the display control unit switches the display mode in the case where the same risk level continues for a particular time in the normal display mode.

### 6

In the navigation assistance device described in any one of (1) to (5), the display control unit immediately switches the display mode in response to a change in the risk level in the setting reception mode.

### 7

In the navigation assistance device described in any one of (1) to (6), there are at least two thresholds, and there are at least three risk levels.

### 8

In the navigation assistance device described in any one of (1) to (7), the threshold is a time threshold. Based on the first ship data and the second ship data, the risk level determining unit calculates a time risk value based on time until the first ship reaches the risk area, compares the time risk value with the time threshold, and determines the risk level.

### 9

In the navigation assistance device described in (8), the setting receiving unit receives setting of the time threshold.

### 10

In the navigation assistance device described in any one of (1) to (9), the threshold is a distance threshold. Based on the first ship data and the second ship data, the risk level determining unit calculates a distance risk value based on a distance from the first ship to the risk area on a course of the first ship, compares the distance risk value with the distance threshold, and determines the risk level.

### 11

In the navigation assistance device described in (10), the setting receiving unit receives setting of the distance threshold.

### 12

In the navigation assistance device described in any one of (1) to (11), the threshold is a time threshold and a distance threshold. Based on the first ship data and the second ship data, the risk level determining unit calculates a time risk value based on time until the first ship reaches the risk area and a distance risk value based on a distance from the first ship to the risk area on a course of the first ship, compares the time risk value with the time threshold, compares the distance risk value with the distance threshold, and determines the risk level.

### 13

In the navigation assistance device described in any one of (1) to (12), the first ship data includes the position of the first ship measured by a positioning device mounted on the first ship.

### 14

In the navigation assistance device described in any one of (1) to (13), the second ship data includes the position and speed of the second ship detected by a radar or AIS mounted on the first ship.

### 15

A navigation assistance method includes: acquiring first ship data including position and speed of a first ship; acquiring second ship data including position and speed of a second ship; based on the first ship data and the second ship data, calculating a risk area where there is a risk of collision between the first ship that is assumed to proceed in an arbitrary direction and the second ship that is assumed not to change course; based on the first ship data, the second ship data, and a threshold, determining a risk level with respect to the risk area; displaying the risk area in a display mode corresponding to the risk level in an image indicating a positional relationship between the first ship, the second ship, and the risk area; and causing a timing of switching of the display mode to differ between a normal display mode and a setting reception mode in which setting of the threshold is received.

### 16

A program is for causing a computer to execute: acquiring first ship data including position and speed of a first ship; acquiring second ship data including position and speed of a second ship; based on the first ship data and the second ship data, calculating a risk area where there is a risk of collision between the first ship that is assumed to proceed in an arbitrary direction and the second ship that is assumed not to change course; based on the first ship data, the second ship data, and a threshold, determining a risk level with respect to the risk area; receiving setting of the threshold; displaying the risk area in a display mode corresponding to the risk level in an image indicating a positional relationship between the first ship, the second ship, and the risk area; and causing a timing of switching of the display mode to differ between a normal display mode and a setting reception mode in which the setting of the threshold is received.

### Terminlogy

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately,” “about,” and “substantially” as used herein include the recited numbers, and also represent an amount close to the stated amount that still performs a desired function or achieves a desired result. For example, unless otherwise explicitly stated, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

Although the present disclosure may describe certain embodiments with reference to a particular type of mobile platform, the techniques disclosed herein are not limited thereto and may be applied, with appropriate modifications, to various types of mobile platforms operating in different environments, such as marine, aerial, or terrestrial environments, without departing from the spirit of the disclosure. For example, such mobile platforms are not limited to vessels and may include vehicles and aircraft.

As used herein, the terms “vessel,” “watercraft,” “ship,” “boat,” and other related terms used in this specification should be interpreted to include any marine craft capable of navigating on or through water, whether manned or unmanned, unless otherwise noted.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A navigation assistance device comprising:
processing circuitry configured to:
acquire first ship data including a position and a speed of a first ship;
acquire second ship data including a position and a speed of a second ship;
based on the first ship data and the second ship data, calculate a risk area in which there is a risk of collision between the first ship that is assumed to proceed in an arbitrary direction and the second ship that is assumed not to change course;
based on the first ship data, the second ship data, and a threshold, determine a risk level with respect to the risk area;
receive setting of the threshold; and
display the risk area in a display mode corresponding to the risk level in an image indicating a positional relationship among the first ship, the second ship, and the risk area; and
cause a timing of switching of the display mode to differ between a normal display mode and a setting reception mode in which the setting of the threshold is received.

2. The navigation assistance device according to claim 1, wherein the processing circuitry is further configured to:
cause a switching time from changing of the risk level until switching of the display mode to differ between the normal display mode and the setting reception mode.

3. The navigation assistance device according to claim 2, wherein the processing circuitry is further configured to:
make the switching time in the setting reception mode shorter than the switching time in the normal display mode.

4. The navigation assistance device according to claim 1, wherein
the setting reception mode includes a state in which a setting screen that receives the setting of the threshold is displayed, and the normal display mode includes a state in which the setting screen is not displayed.

5. The navigation assistance device according to claim 2, wherein
the setting reception mode includes a state in which a setting screen that receives the setting of the threshold is displayed, and the normal display mode includes a state in which the setting screen is not displayed.

6. The navigation assistance device according to claim 3, wherein
the setting reception mode includes a state in which a setting screen that receives the setting of the threshold is displayed, and the normal display mode includes a state in which the setting screen is not displayed.

7. The navigation assistance device according to claim 1, wherein the processing circuitry is further configured to:
switch the display mode in a case where the same risk level continues for a preset time in the normal display mode.

8. The navigation assistance device according to claim 1, wherein the processing circuitry is further configured to:
immediately switch the display mode in response to a change in the risk level in the setting reception mode.

9. The navigation assistance device according to claim 1, wherein
there are at least two thresholds, and
there are at least three risk levels.

10. The navigation assistance device according to claim 1, wherein
the threshold is a time threshold; and
the processing circuitry is further configured to:
based on the first ship data and the second ship data, calculate a time risk value based on a time until the first ship reaches the risk area; and
compare the time risk value with the time threshold and determine the risk level.

11. The navigation assistance device according to claim 8, wherein the processing circuitry is further configured to:
receive setting of the time threshold.

12. The navigation assistance device according to claim 1, wherein
the threshold is a distance threshold; and
the processing circuitry is further configured to:
based on the first ship data and the second ship data, calculate a distance risk value based on a distance from the first ship to the risk area on a course of the first ship; and
compare the distance risk value with the distance threshold and determine the risk level.

13. The navigation assistance device according to claim 10, wherein the processing circuitry is further configured to:
receive setting of the distance threshold.

14. The navigation assistance device according to claim 1, wherein
the threshold includes a time threshold and a distance threshold; and
the processing circuitry is further configured to:
based on the first ship data and the second ship data, calculate a time risk value based on a time until the first ship reaches the risk area and a distance risk value based on a distance from the first ship to the risk area on a course of the first ship; and
compare the time risk value with the time threshold, compare the distance risk value with the distance threshold, and determine the risk level.

15. The navigation assistance device according to claim 1, wherein
the first ship data includes the position of the first ship measured by a positioning device mounted on the first ship.

16. The navigation assistance device according to claim 1, wherein
the second ship data includes the position and speed of the second ship detected by a radar or automatic identification system (AIS) mounted on the first ship.

17. A navigation assistance method comprising:
acquiring first ship data including a position and a speed of a first ship;
acquiring second ship data including a position and a speed of a second ship;
based on the first ship data and the second ship data, calculating a risk area where there is a risk of collision between the first ship that is assumed to proceed in an arbitrary direction and the second ship that is assumed not to change course;
based on the first ship data, the second ship data, and a threshold, determining a risk level with respect to the risk area;
displaying the risk area in a display mode corresponding to the risk level in an image indicating a positional relationship among the first ship, the second ship, and the risk area; and
causing a timing of switching of the display mode to differ between a normal display mode and a setting reception mode in which setting of the threshold is received.

18. A non-transitory computer-readable medium having stored thereon computer-executable instructions which, when executed by a computer, cause the computer to:
acquire first ship data including a position and a speed of a first ship;
acquire second ship data including a position and a speed of a second ship;
based on the first ship data and the second ship data, calculate a risk area where there is a risk of collision between the first ship that is assumed to proceed in an arbitrary direction and the second ship that is assumed not to change course;
based on the first ship data, the second ship data, and a threshold, determine a risk level with respect to the risk area;
receive setting of the threshold;
display the risk area in a display mode corresponding to the risk level in an image indicating a positional relationship among the first ship, the second ship, and the risk area; and
cause a timing of switching of the display mode to differ between a normal display mode and a setting reception mode in which the setting of the threshold is received.
